(19) United States
(12) Patent Application Publication
(10) Pub. No.: US 2011/0203532 A1
(43) Pub. Date: Aug. 25, 2011

(54) NON-PULL LEASH SYSTEM AND METHOD

(75) Inventors: Lourdes Edlin, Miami, FL (US); Donna Arnett, Miami, FL (US)

(73) Assignee: INCREDIBLE DOG STUFF, INC., Miami, FL (US)

(21) Appl. No.: 13/029,546

(22) Filed: Feb. 17, 2011

Related U.S. Application Data
(60) Provisional application No. 61/306,074, filed on Feb. 19, 2010.

(51) Int. Cl. A01K 27/00

(52) U.S. Cl. 119/792

(57) ABSTRACT

A non-pull leash system including a collar, a leash, and a karabiner attached to the proximal end of a clip. In some embodiments, karabiner has at least one gap and at least one gate. The distal end of the clip is attached to the collar and the proximal end of the leash is attached to the karabiner by way of the gate. In use, the collar is secured to a neck of an animal and the distal end of the leash is wrapped down the first side of the animal, around the upper torso of the animal, and up the other side of the animal. The distal end of the leash is then received by the at least one gap of the karabiner, resulting in a slip-knot at the karabiner. The non-pull leash system prevents a subject animal from pulling excessively against its collar and leash and, in turn, improves the handler's ability to control the animal.

### PRIORITY INFORMATION

This application claims the benefit of U.S. Provisional Application No. 61/306,074, filed Feb. 19, 2010.

### BACKGROUND OF THE INVENTION

The present invention relates generally to leashes, leads, and collars for domesticated animals such as canines. More specifically, the present invention relates to various embodiments of a leash system that is designed to prevent the animal wearing the leash from pulling excessively against its collar and leash and, in turn, its handler. The present invention also concerns methods associated with the system described herein.

### SUMMARY OF THE INVENTION

Disclosed herein are various embodiments of the components of the non-pull leash system of the present invention. In some embodiments, the system of the present invention comprises a collar adapted to be secured to a neck of an animal, a leash, and a karabiner attached to a proximal end of a clip, wherein the karabiner has at least one gap and at least one gate, wherein a distal end of the clip is attached to the collar, wherein a proximal end of the leash is attached to the karabiner through the at least one gate, wherein a distal end of the leash is wrapped down a first side of the animal, around the upper torso of the animal, and up a second side of the animal, and wherein the distal end of the leash is received by the at least one gap, resulting in a slip-knot at the karabiner.

Further, in some embodiments, the karabiner is swivel mounted to the clip. Further, in some embodiments, the proximal end of the leash is attached to the karabiner by a ring, wherein the ring is connected to the proximal end of said leash.

In some embodiments, the karabiner further comprises an outer ring and a cross member, the cross member delimiting a first gap and a second gap, wherein the outer ring further comprises a first gate permitting access to the first gap, and a second gate permitting access to the second gap. In this embodiment, the proximal end of the leash is attached to the first gap of the clip through the first gate, the distal end of the leash is wrapped down the first side of the animal, around the upper torso of the animal, and up the second side of the animal, and the distal end of the leash is received by the second gap of the karabiner.

Further disclosed is a device for the non-pull leash system of the present invention comprising a clip and a karabiner, the karabiner having a gate permitting access to a primary gap thereof, wherein a proximal end of the clip is swivel mounted to a proximal end of the karabiner. In some embodiments, the swivel mount comprises a sleeve at the proximal end of the karabiner adapted to receive the lower shank of the clip. In some embodiments, the shank is retained in the sleeve by a protrusion at the proximal end of the shank. Alternatively, the shank is retained in the sleeve by a screw inserted into the proximal end of the shank.

Accordingly, it is an object of the present invention to provide an effective means for handling a domesticated animal, such as a canine, while minimizing the risk of injury to the pet and its handler. It is a further object of the present to provide a non-pull leash that is effective for training, maintaining, and correcting the behavior of domesticated animals. It is a further object of the present invention to provide a non-pull leash system that can be put on the subject animal with relative ease, even when dealing with an excited or rambunctious animal. It is a further embodiment of the present invention to provide an improved non-pull leash that stays in place on the animal and thus minimizes the risk of injury to the animal during use.

Additional advantages of the present invention will be readily apparent upon a thorough review of the disclosure and figures that follow.

### BRIEF DESCRIPTION OF THE DRAWINGS

FIG. 1 is a top view of one embodiment of the present invention.

FIG. 2 is an aspect view of one embodiment of the present invention shown with a leash in the operating position.

FIG. 3 is an aspect view of one embodiment of the present invention in use on a canine.

FIG. 4 is a top view of another embodiment of the present invention.

FIG. 5 is a top view of yet another embodiment of the present invention.

FIG. 6 is top view of yet another embodiment of the present invention.

### DETAILED DESCRIPTION OF THE INVENTION

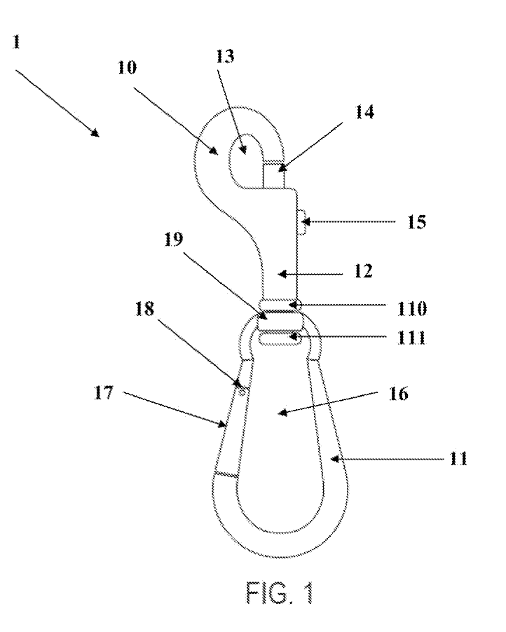

The non-pull leash system of the present invention contemplates various embodiments of an attachment device that is intended to be used in conjunction with a collar and leash. With reference to FIG. 1, shown is one embodiment of the attachment device 1, comprising a clip 10 and karabiner 11. Clip 10 has a shank 12 and a curved opening 13 at its distal end which is closed by spring-loaded latch 14. In some embodiments, latch 14 is momentarily opened by pressing tang 15, which causes latch 14 to momentarily retract into shank 12.

For the purposes of this disclosure, a “karabiner” refers to any device comprising a rigid loop having one or more gaps and one or more spring-loaded or threaded “gates” or latches. Accordingly, as shown, in some embodiments, karabiner 11 has an oblong shape and a primary gap 16. Spring-loaded gate 17 is coincident with the body of karabiner 11 and is pivotably mounted thereto at joint 18. In some embodiments, gate 17 is attached to karabiner 11 at point 18 by a rivet or a pin. As shown, the proximal end of clip 10 is swivel mounted to the proximal end of karabiner 11. Accordingly, in some embodiments, clip 10 is retained by sleeve 19, which is integrated into the proximal end of karabiner 11. In some embodiments, clip 10 is retained in sleeve 19 on either side by protrusions 110 and 111 which extend radially from shank 12. In some embodiments, protrusion 111 is be the head of a screw, nail, or other like fitting which is inserted into the proximal end of shank 12.

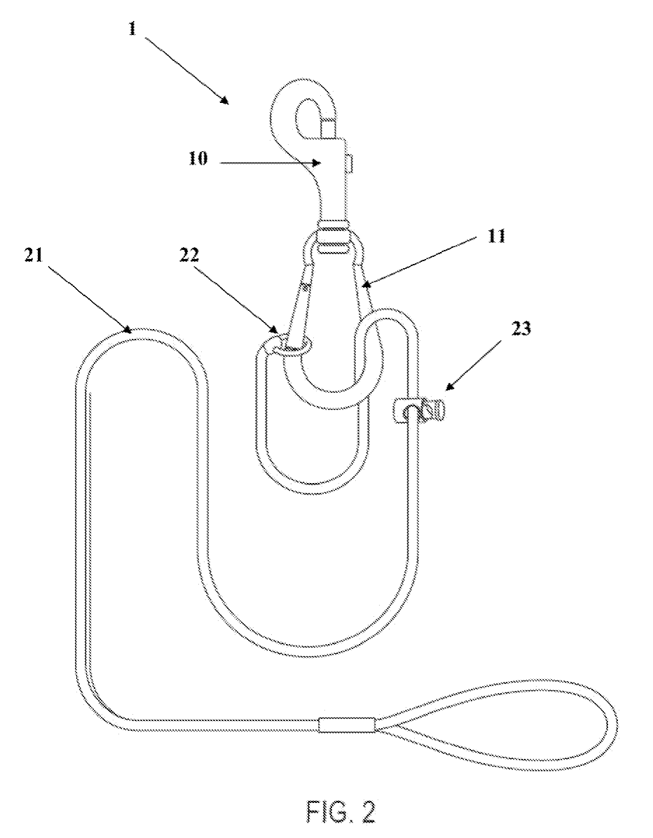

FIG. 2 depicts device 1 in conjunction with a leash 21. In some embodiments, leash 21 is comprised of a webbing material such as cloth or nylon and has a small loop at its proximal end for receiving a leash ring 22 and a large loop at its distal end to promote grippability and comfort for the handler. It other embodiments, leash ring 22 may be omitted entirely or may be replaced by any number of suitable substitutes such as a spring loaded clasp commonly found on pet leashes. For the purposes of this disclosure, the shape, size, and material of leash 21 shall not be construed as limiting. Accordingly, leash 21 may be comprised of any suitable material such as nylon, plastic, cotton, leather, and the like and may have a cross section that is substantially flat, circular, rectangular, or the like. Leash 21 may also have an adjustable stopper 23 that will function to prevent excessive slack in leash 21 when it is in use.

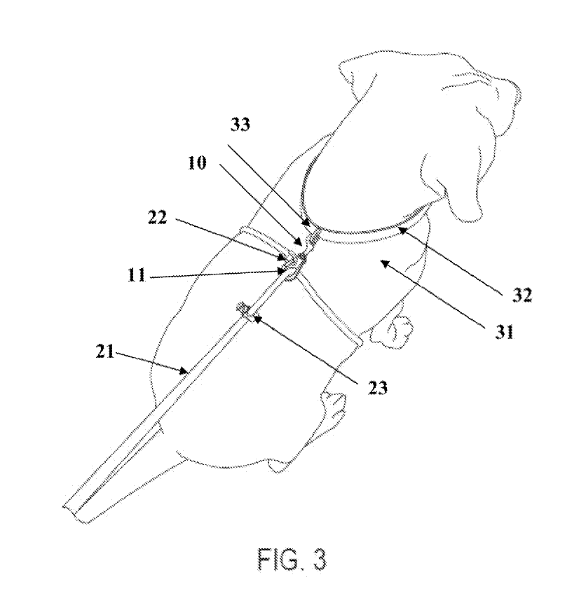

FIG. 3 depicts the non-pull leash system of the present invention in operation on a subject animal 31. As is generally known in the art, collar 32 is placed around the neck of the subject animal (i.e. behind the ears but in front of the shoulder blades). In some embodiments collar 32 is closed around the animal's neck by plastic retaining clasp. However, collar 32 of present invention need not be limited to those having a plastic clasp, rather there are various substitutes for the clasp known in the art that are equally well suited, such as buttons, snaps, d-rings, and the like. Collar 32 also has an attachment ring 33 which may be circular, D-shaped, or the like.

In accordance with the method of the present invention, as shown, collar 32 is secured around the neck of the subject animal and the distal end of clip 10 is attached to attachment ring 33, such that device 1 lies substantially flat at the top of the animal's neck, just above the shoulder blades. Collar 32 should be relatively taut around the animal's neck, but not so taut as to constrict the animal's neck. Next, ring 22 (which is attached to the proximal end of leash 21) is attached to karabiner 11 through gate 17. At this point, the distal end of leash 21 should be slack. Next, leash 21 is wrapped down and around the upper torso of the subject animal such that it comes up and back toward device 1. Leash 21 may be wrapped in either direction, depending on the handler's choice.

Next, the distal end of leash 21 is brought though and received by gap 16, thus creating a “slip-knot” by way of karabiner 11. Accordingly, when tension is applied to the distal end of leash 21 either by the animal or the handler, the slack in leash 21 is forced through gap 16 and away from the animal, causing the portion of the leash 21 that is wrapped around the animal's upper torso to tighten. This slight tightening action around the animal's torso is sufficient to either slow or completely stop the animal's gait. Additionally, the above mentioned stopper 23 can be adjusted to prevent excessive slack in leash 21 and also to prevent leash 21 from completely disengaging from karabiner 11.

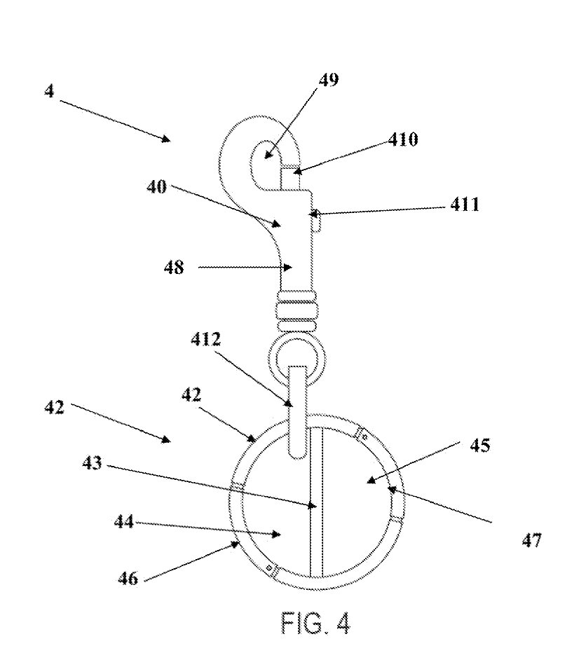

FIG. 4 is another embodiment of the present invention, with an alternative attachment device configuration. As shown, attachment device 4 comprises a clip 40 and a karabiner 41. karabiner 41 comprises an outer ring 42 and a cross-member 43, delimiting two gaps 44 and 45. Outer ring 42 also has two spring loaded gates 46 and 47 permitting access to gaps 44 and 45, respectively. Clip 40 has a shank 48 and a curved opening 49 at its distal end which is closed by spring-loaded latch 410. In some embodiments, latch 410 is momentarily opened by pressing tang 411, which causes latch 410 to momentarily retract into shank 48. As shown, clip 40 is secured to karabiner 41 by strap 412, which may be secured through either or both gaps 44 and 45.

Although not pictured, the non-pull leash systems utilizing attachment means 4 operates much like that described above. Thus, in accordance with the method of the present invention Collar 32 is secured around the neck of the subject animal and the distal end of clip 40 is attached to attachment ring 34, such that device 4 lies substantially flat at the top of the animal's neck, just above the shoulder blades. Collar 32 should be relatively taut around the animal's neck, but not so taut as to constrict the animal's neck. Next, ring 22 (which is attached to the proximal end of leash 21) is attached to karabiner 41 through either gap 44 or gap 45, via gate 46 or gate 47, respectively. At this point, the distal end of leash 21 should be slack. Next, leash 21 is wrapped down and around the upper torso of the subject animal such that it comes up and back toward device 4. Preferably, leash 21 first travels around the subject animal's body on the same side as the gap 44 or 45 to which leash 21 is attached.

Next, the distal end of leash 21 is brought through the other, free gap (either 44 or 45), thus creating a “slip-knot” by way of karabiner 41. The distal end of leash 21 can either be fed through the free gap manually, or the handler may simply pass the leash 21 through the gate (either 46 or 47) for quicker attachment. Accordingly, when tension is applied to the distal end of leash 21 either by the animal or the handler, the slack in leash 21 is forced through the gap and away from the animal, causing the portion of the leash 21 that is wrapped around the animal's upper torso to tighten. Stopper 23 can be adjusted to prevent excessive slack in leash 21 and also to prevent leash 21 from completely disengaging from karabiner 41.

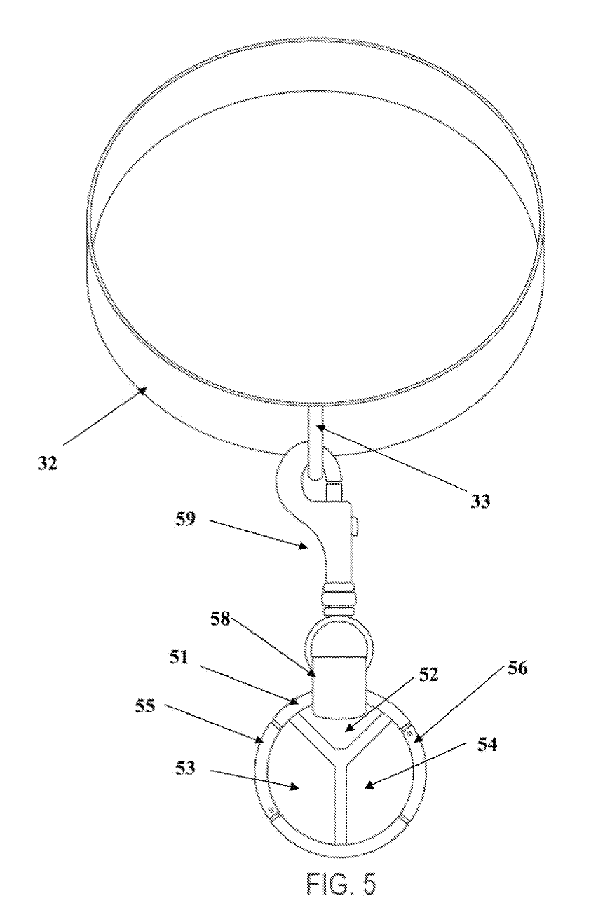

FIG. 5 is yet another embodiment of the present invention, with an alternative attachment device configuration. Shown is trifurcated karabiner 51 having gaps 52, 53, and 54 and gates 55 and 56. karabiner 51 may be attached to spring-loaded clip 59 by strap 58, which in turn is connected to ring 33 of collar 32. In some embodiments, strap 58 may be attached directly to collar 32, wherein clip 59 and ring 33 are omitted.

It may be preferred for karabiner 51 to be attached to collar 32 at a position substantially opposite of the location of the retaining clasp (i.e. 180° therefrom). In this arrangement, when collar 32 is secured to the subject animal's neck, retaining clasp may be located underneath the animal's chin and karabiner 51 may be located on the top of the animal's neck, at the animal's shoulder blades.

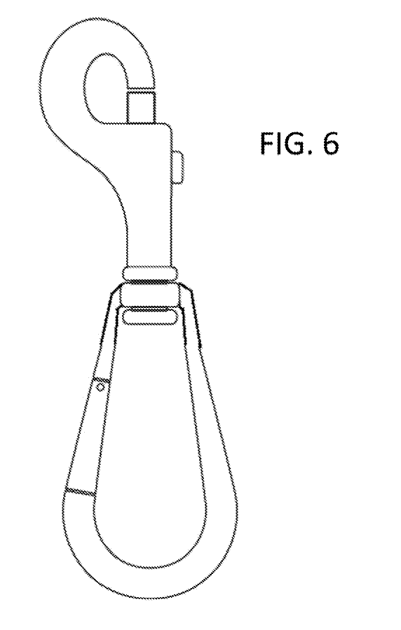

It is understood herein that the various described karabiners incorporated into the present invention need not be limited in shape, size or geometry, provided that it permits the user to create a “slip-knot” at the top of the subject animal's back/shoulder blades when the leash is wrapped around the torso thereof. Accordingly, the karabiner may also have any number of gates permitting access or any number of gaps. Another embodiment of the device is present invention is shown in FIG. 6, having a bell-shaped karabiner.

In accordance with the foregoing, the present invention is useful for preventing the subject animal from pulling excessively against its leash. In that sense, the present invention can be used as a training tool, a preventative tool, and/or a corrective tool depending on the desired use.

Further still, in accordance with the above described embodiments, leash 21 is capable of serving functions, including but not limited to the following:

Firstly, it may be used in the manner described as part of the non-pull leash system. Secondly, it may be used as a standard leash that may be attached to a collar in a variety of known ways such as by using circular rings, d-rings, spring clips, and the like. Thirdly, it may be used as a “slip-lead,” as is commonly known in the dog training industry whereby leash 21 is placed around the neck of the subject animal and the distal end thereof is fed through ring 22 creating a “slip-knot.”

In the foregoing description, the present invention has been described with reference to specific exemplary embodiments thereof. It will be apparent to those skilled in the art that a person understanding this invention may conceive of changes or other embodiments or variations, which utilize the principles of this invention without departing from the broader spirit and scope of the invention. The specification and drawings are, therefore, to be regarded in an illustrative rather than a restrictive sense.

We claim:

1. A non-pull leash system, comprising:
a collar adapted to be secured to a neck of an animal;
a leash;
a karabiner attached to a proximal end of a clip, wherein said karabiner has at least one gap and at least one gate;
wherein a distal end of said clip is attached to said collar;
wherein a proximal end of said leash is attached to said karabiner through said at least one gate;
wherein a distal end of said leash is wrapped down a first side of said animal, around the upper torso of said animal, and up a second side of said animal;
and wherein said distal end of said leash is received by said at least one gap, resulting in a slip-knot at said karabiner.

2. The non-pull leash system of claim 1, wherein said proximal end of said leash is attached to said karabiner by a ring, said ring connected to said proximal end of said leash.

3. The non-pull leash system of claim 1, wherein said karabiner is swivel mounted to said clip.

4. The non-pull leash system of claim 1, wherein said karabiner further comprises an outer ring and a cross member, said cross member delimiting a first gap and a second gap.

5. The non-pull leash system of claim 4, wherein said outer ring further comprises a first gate permitting access to said first gap, and a second gate permitting access to said second gap.

6. The non-pull leash system of claim 5, wherein said proximal end of said leash is attached to said first gap of said karabiner through said first gate, said distal end of said leash is wrapped down said first side of said animal, around said upper torso of said animal, and up said second side of said animal; and wherein said distal end of said leash is received by said second gap of said karabiner.

7. The non-pull leash system of claim 1, wherein said clip further comprises a spring loaded latch for momentarily opening said clip.

8. A device for a non-pull leash system, comprising:
a clip;
a karabiner, said karabiner having a gate permitting access to a primary gap of said karabiner;
wherein a proximal end of said clip is swivel mounted to a proximal end of said karabiner.

9. The device of claim 8, wherein said swivel mount comprises a sleeve at said proximal end of said karabiner adapted to receive a shank of said clip.

10. The device of claim 9, wherein said shank of said clip is retained in said collar by a protrusion at a proximal end of said shank.

11. The device of claim 9, wherein said shank of said clip is retained in said collar by a screw inserted into a proximal end of said shank.

12. The device of claim 8, wherein said clip is adapted to removably engage a collar, wherein said collar is adapted to be secured to the neck of an animal.

13. The device of claim 12, wherein said karabiner is adapted to receive the proximal end of a leash.

14. The device of claim 13, wherein a distal end of said leash is wrapped down a first side of said animal, around the upper torso of said animal, and up a second side of said animal.

15. The device of claim 14, wherein said distal end of said leash is received by said primary gap, resulting in a slip-knot at said karabiner.

16. A method for utilizing a non-pull leash system, comprising:
securing a collar to a neck of an animal;
attaching a distal end of a clip to said collar, wherein a karabiner is attached to a proximal end of said clip and has at least one gap and at least one gate;
connecting a proximal end of a leash to said karabiner through said at least one gate;
wrapping a distal end of said leash down a first side of said animal, around the upper torso of said animal, and up a second side of said animal;
whereby said distal end of said leash is received by said at least one gap, resulting in a slip-knot at said karabiner.

17. The method of claim 16, wherein said proximal end of said leash is attached to said karabiner by a ring, said ring connected to said proximal end of said leash.

18. The method of claim 16, wherein said karabiner is swivel mounted to said clip.

19. The method of claim 16, wherein said karabiner further comprises an outer ring and a cross member, said cross member delimiting a first gap and a second gap.

20. The method of claim 19, wherein said outer ring further comprises a first gate permitting access to said first gap, and a second gate permitting access to said second gap.

21. The method of claim 20, whereby said proximal end of said leash is attached to said first gap of said karabiner through said first gate, said distal end of said leash is wrapped down said first side of said animal, around said upper torso of said animal, and up said second side of said animal; and wherein said distal end of said leash is received by said second gap of said karabiner.

22. The method of claim 16, wherein said clip further comprises a spring loaded latch for momentarily opening said clip.
